(19) United States
(12) Patent Application Publication
(10) Pub. No.: US 2009/0090472 A1
(43) Pub. Date: Apr. 9, 2009

(54) LIQUID EVAPORATOR

(75) Inventor: Klaus RADOMSKI, Lubeck (DE)

Correspondence Address: MCGLEW & TUTTLE, PC, P.O. BOX 9227, SCARBOROUGH STATION, SCARBOROUGH, NY, 10510-9227, US

(73) Assignee: Drager Medical AG & Co. KG, Lubeck (DE)

(21) Appl. No.: 12/207,660

(22) Filed: Sep. 10, 2008

(30) Foreign Application Priority Data
Oct. 4, 2007 (DE) 10 2007 047 415.8

(51) Int. Cl. B01D 1/00

(52) U.S. Cl. 159/43.1

(57) ABSTRACT

A liquid evaporator with a liquid reserve (1) of a liquid to be evaporated, with at least one liquid feed duct (2, 22, 23, 24), with an evaporating unit (16) adjoining the at least one liquid feed duct (2, 22, 23, 24), with at least one working electrode (3, 4), which forms at least one portion of a wall of the liquid feed duct (2, 22, 23, 24), and at least one counterelectrode (7, 8) arranged at a spaced location from the at least one working electrode (3, 4). An electrical field generated by an electric voltage between the working electrode (3, 4) and the counterelectrode (7, 8) brings about motion of the liquid through the liquid feed duct (2, 22, 23, 24).

### CROSS REFERENCE TO RELATED APPLICATIONS

This application claims the benefit of priority under 35 U.S.C. §119 of German Patent Application DE 10 2007 047 451.8 filed Oct. 4, 2007, the entire contents of which are incorporated herein by reference.

### FIELD OF THE INVENTION

The present invention pertains to a liquid evaporator and to a process for generating vapor from a liquid to be evaporated.

### BACKGROUND OF THE INVENTION

Liquid evaporators, which are used to release an anesthetic or as respiration humidifiers for a patient, are known from respiration technique.

In a liquid evaporator known from DE 10 2005 054 344 B3, a liquid to be evaporated is delivered into a liquid feed duct by means of capillary forces. The liquid evaporator has no movable parts. The capillary pump consists of a porous material, especially sintered glass or sintered ceramic, which is in connection with the liquid to be evaporated. The water moving by the capillary effect is evaporated in the liquid feed duct heated from the outside. A porous material acting as a capillary wick is arranged for this in the liquid feed duct. A certain quantity of vapor can be generated from the liquid to be evaporated with a regulation of the temperature of the liquid feed duct heated from the outside. One drawback of the prior-art device is thermal inertia, especially the delayed motion of the liquid in the liquid feed duct, and the duration of heating of the heating elements and hence of the liquid feed duct. There is only limited or no possibility to guarantee that vapor will be available in a short time.

The prior-art liquid evaporator is suitable for providing vapor continuously, which can be embodied without problems. Delays may occur in the supply of vapor in case of intermittent vapor generation for the above-mentioned reasons.

A liquid evaporator is used, among other things, with a respirator, especially in an open respiration system. A respirator generates breathing air during the patient's inspiration phase. The expiration air of the expiration phase is discharged into the environment in an open system. The breathing air of the inspiration phase is enriched with moisture. Thus, vapor is needed during the inspiration phase only.

Continuous production of vapor makes necessary the intermediate storage of a large quantity of vapor during the patient's expiration phase at low respiration rates and large tidal volumes especially when the liquid evaporator known from DE 10 2005 054 344 B3 is used with a respirator. Intermediate storage of vapor is, however, difficult to achieve, because vapor that is generated may easily condense under the relatively cold ambient conditions.

Vapor production exclusively during a phase of inspiration would therefore be advantageous. A humidifier with a mechanical pump, as it is described in DE 198 08 590 B2, can embody, in principle, the short-term provision of vapor. However, parts subject to wear, which must be replaced by the user at regular intervals, are present in a mechanical pump.

### SUMMARY OF THE INVENTION

Based on the state of the art, the object of the present invention is to provide a liquid evaporator, which makes it possible to supply vapor rapidly and, in particular, does not require a mechanical pump.

This object is accomplished by a liquid evaporator and a process for generating vapor from a liquid to be evaporated according to the invention.

The liquid evaporator according to the present invention is provided, at a liquid reserve of a liquid to be evaporated, at least one liquid feed duct and an evaporating unit adjoining the at least one liquid feed duct, with at least one working electrode and at least one counterelectrode arranged at a spaced location from the at least one working electrode. An electrical field generated by an electrical voltage between the at least one working electrode and the at least one counterelectrode brings about a motion of the liquid to be evaporated through the liquid feed duct. The design of the liquid evaporator according to the present invention makes it possible for the liquid to be evaporated to move by means of the electrocapillarity within the at least one liquid feed duct and to be evaporated in the process at the same time by the evaporating unit in the liquid feed duct or adjacent to the liquid feed duct. The at least one working electrode forms at least one portion of a wall of the liquid feed duct.

The phenomenon of electrocapillarity takes advantage of the fact that the surface tension of liquids can be modified by the generation of an electrical field. The contact angle between the liquid and the wall of the liquid feed duct thus changes as well. It is thus possible to let the liquid to be evaporated move in the liquid feed duct by reducing the contact angle from over 90° (hydrophobic state) to an angle of less than 90° (hydrophilic state).

The at least one working electrode is advantageously provided with a hydrophobic layer. The at least one working electrode has no direct contact with the liquid to be evaporated. One advantage of this embodiment is that when an electrical voltage is applied between the at least one working electrode and the counterelectrode, no electrolysis can take place. Thus, a higher voltage can be applied between the at least one working electrode and the counterelectrode compared to a working electrode without a hydrophobic layer. It is also possible to use corrosive liquids to be evaporated.

In another advantageous embodiment, the hydrophobic layer of the at least one working electrode consists at least partly of Polytetrafluoroethylene (PTFE also known as Teflon®). Teflon® has a high heat resistance, so that the at least one heating element of the evaporating unit can be arranged in this embodiment in the longitudinal direction of the liquid feed duct. The heating element may surround the liquid feed duct.

In yet another preferred embodiment, the at least one working electrode completely surrounds at least part of the liquid feed duct. Motion of the liquid to be evaporated can be advantageously accelerated hereby.

Furthermore, another liquid feed duct with another working electrode may be provided in the liquid evaporator according to the present invention. The additional working electrode can be connected to another counterelectrode or to the counterelectrode of the working electrode of the first liquid feed duct.

Here or in another embodiment of the liquid evaporator according to the present invention, the working electrode of a first liquid feed duct with the counterelectrode and each additional working electrode of each additional liquid feed duct with each additional counterelectrode can be supplied with voltage separately. The respective working electrodes with the counterelectrodes belonging to them can be actuated individually with correspondingly arranged switching elements. A larger quantity of vapor can be generated from the liquid to be evaporated in a short time as a result. However, the respective working electrodes may also be supplied by a single voltage supply unit only, in which case separate switching on and switching off of the respective working electrode can be made possible with switching elements, which are arranged between the voltage supply unit and the respective working electrode.

The present invention will be explained in more detail with reference to the drawings attached, in which identical structures are designated by the same reference numbers. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1a is a schematic sectional view of a first embodiment of the liquid evaporator according to the present invention, showing a switching element in an open state;

FIG. 1b is a schematic sectional view of a first embodiment of the liquid evaporator according to the present invention, showing a switching element in a closed state;

FIG. 2 is a schematic sectional view of the liquid evaporator according to the present invention with a working electrode surrounding the liquid feed duct;

FIG. 3 is a schematic sectional view of the liquid evaporator according to the present invention in an embodiment with a plurality of liquid feed ducts;

FIG. 4 is a schematic sectional view of the liquid evaporator according to the present invention in an embodiment with porous material between two respective liquid feed ducts;

FIG. 5 is a schematic sectional view of the liquid evaporator according to the present invention with three liquid feed ducts of rectangular cross section; and

FIG. 6 is a schematic sectional view of the liquid evaporator according to the present invention with three liquid feed ducts of different cross-sectional areas.

### DESCRIPTION OF THE PREFERRED EMBODIMENTS

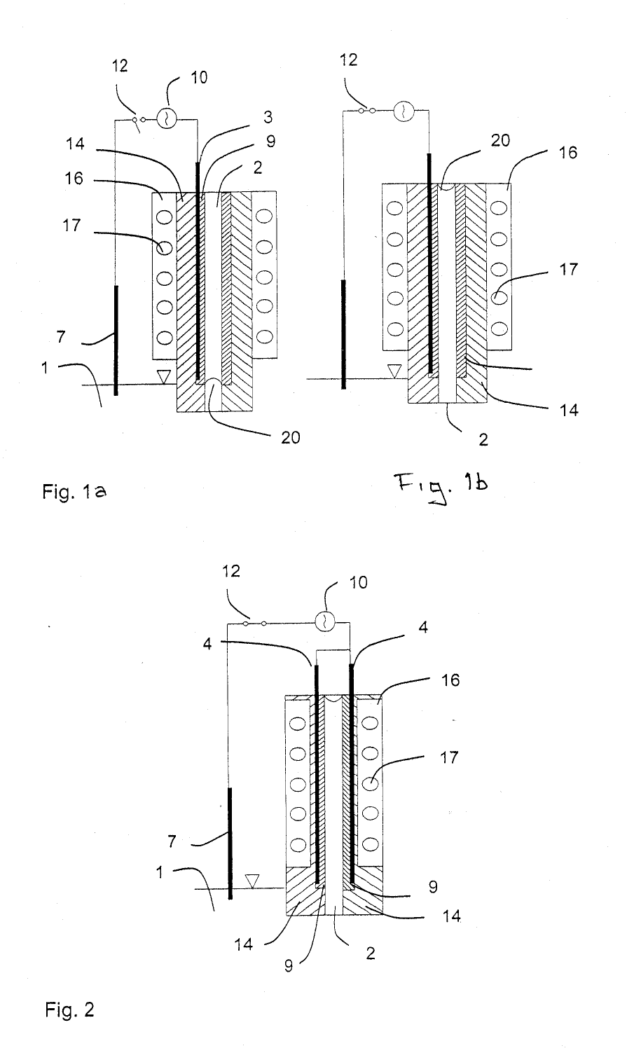

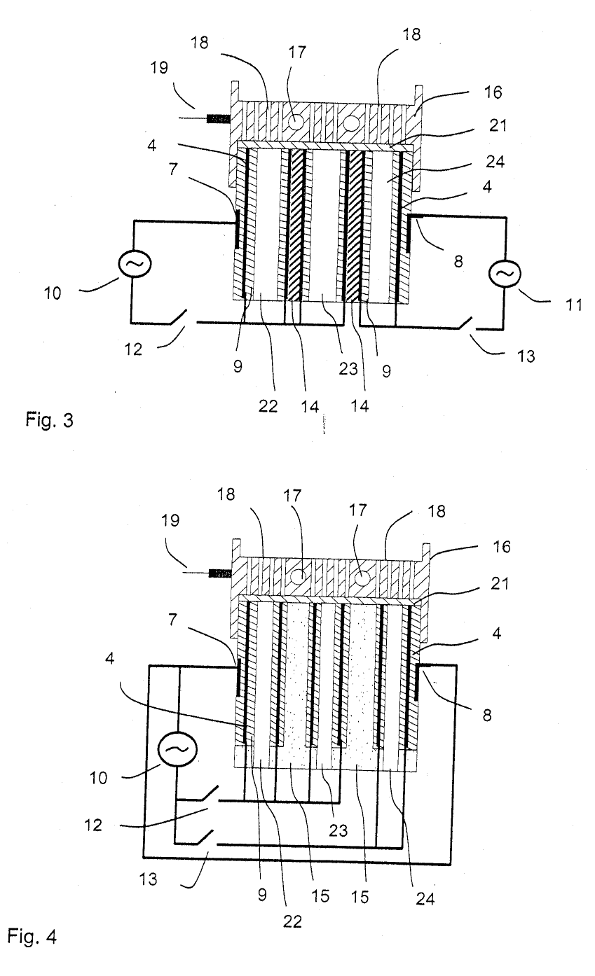

Referring to the drawings in particular, FIGS. 1a and 1b each show a liquid evaporator each with a working electrode 3 and with a counterelectrode 7 arranged at a spaced location from the working electrode 3. The working electrode 3 forms part of a wall of a liquid feed duct 2. The liquid feed duct 2 is connected to a liquid reserve 1 of a liquid to be evaporated. The surface of the working electrode 3 is provided with a hydrophobic layer 9. The hydrophobic layer 9 preferably consists of Teflon® (PTFE). The hydrophobic layer 9 is in connection within the liquid feed duct 2 with the liquid of the liquid reserve 1, which liquid is to be evaporated. In another embodiment, not shown, the working electrode 3, may, however, be directly in contact with the liquid to be evaporated. The wall side of the liquid feed duct 2 arranged opposite the working electrode 3 is preferably provided with a hydrophobic layer 9. The working electrode 3 extends nearly over the entire axial length of the liquid feed duct 2 and is held by a carrier unit 14. The material of the carrier unit 14 preferably consists of silicon. The carrier unit 14 is adjoined in the circumferential direction by an evaporating unit 16, which comprises five heating elements 17 arranged at spaced locations from one another. The evaporating unit 16 is arranged in the longitudinal direction of the liquid feed duct 2. The evaporating unit 16 may also be arranged within the carrier unit 14 in another embodiment (FIG. 2). The liquid feed duct 2 is directly surrounded by the heating elements 17 of the evaporating unit 16 in the embodiments according to FIG. 1 and is indirectly surrounded by the heating elements 17 of the evaporating unit 16 in the embodiment according to FIG. 2. In another embodiment, the heating elements 17 of the evaporating unit 16 may be arranged in the direction of flow of the liquid to be evaporated, downstream of the liquid feed duct 2 (not shown in FIGS. 3 and 4).

The distance between the working electrode 3 and the counterelectrode 7 is selected to be such that the application of an electrical voltage of a voltage supply unit 10 by a switching element 12 between the working electrode 3 and the counterelectrode 7 generates an electrical field that brings about a motion of the liquid to be evaporated from the liquid reserve 1 into the liquid feed duct 2. The electrical voltage of the voltage supply unit 10 may be either direct current (d.c.) voltage or an alternating current (a.c.) voltage. FIG. 1a shows a liquid level 20 during an open state of the switching element 12. FIG. 1b shows the liquid level 20 during the closed state of the switching element 12. The liquid rising in the liquid feed duct 2 is evaporated by the heat generated by the heating elements 17 in the liquid feed duct 2.

The diameter or the width of the liquid feed duct 2 depends on the electrical voltage of the voltage supply unit 10, which voltage is present between the working electrode 3 and the counterelectrode 7, on the layer thickness and the dielectric constant of the hydrophobic layer 9, the length of the liquid feed duct 2 as well as on the distance between the working electrode 3 and the counterelectrode 7 and the nature of the liquid to be evaporated. Electrically conductive particles in the liquid to be evaporated facilitate the motion of the liquid to be evaporated from the liquid reserve 1 into the liquid feed duct 2. At equal characteristics of the liquid evaporator according to the present invention, the velocity of rise of an electrolyte as a liquid to be evaporated in the liquid feed duct 2 is greater than in case of deionized water or distilled water.

If the voltage of the voltage supply unit 10 is, for example, 220 V, the length of the liquid feed duct 2 is 25 mm, the layer thickness of the hydrophobic layer 9 is 18.5 mm, the dielectric constant of the hydrophobic layer 9 is 2.1, and the liquid to be evaporated is deionized water, the width of the liquid feed duct 2 is approximately 100 μm.

The distance between the working electrode 3 and the counterelectrode 7 is in the range of 1 mm to 10 mm.

The liquid evaporator according to the present invention shown in FIG. 1, in which the width of the liquid feed duct 2 is 100 μm and its length is 25 mm, can generate a velocity of rise of the liquid to be evaporated of 0.5 mm per second at a capillary rise of 25 mm. The applicant was able to determine in experimental studies a flow rate of approximately 0.8 mL per minute of the liquid to be evaporated. The attainable flow rate of the liquid to be evaporated can be increased further by reducing the layer thickness of the hydrophobic layer 9 and/or with a hydrophobic layer 9 of a higher dielectric constant. At the same time, the needed voltage of the voltage supply unit 10 can be significantly reduced at equal flow rate of the liquid to be evaporated.

The schematic sectional view in FIG. 2 shows a second embodiment of the liquid evaporator according to the present invention with a working electrode 4 surrounding the liquid feed duct 2. The working electrode 4 completely surrounds the liquid feed duct 2 in this embodiment. As a result, an electrocapillary effect is enhanced, because the surface tension of the liquid to be evaporated is reduced when an electrical voltage is applied between the working electrode 4 and the counterelectrode 7 from both sides. The working electrode 4 extends, just as in the view in FIG. 1, nearly over the entire axial length of the liquid feed duct 2. The working electrode 4 likewise has a hydrophobic layer 9, but it may also be directly in contact with the liquid to be evaporated in another embodiment (not shown). Furthermore, the working electrode 4 may completely surround only part of the liquid feed duct 2 in another embodiment, but it extends nearly over the entire axial length of the liquid feed duct 2 in this embodiment as well (not shown).

FIG. 3 shows another embodiment of the liquid evaporator according to the present invention with a plurality of liquid feed ducts. The working electrodes 4 are designed according to the description of the design of the working electrode 4 according to FIG. 2. The working electrode 4 of a first liquid feed duct 22 is connected to a switch 12, which connects the working electrode 4 to the voltage supply unit 10 as desired. The voltage supply unit 10 is connected at the same time to the counterelectrode 7. A second working electrode 4, which is electrically connected to the first working electrode 4 of the first liquid feed duct 22, is provided in a second liquid feed duct 23 adjoining the first liquid feed duct 22. A third liquid feed duct 24 adjoining the second liquid feed duct 23 comprises a third working electrode 4, which is connected to a second switching element 13 and has no connection to the working electrodes 4 of the first and second liquid feed ducts 22 and 23. The switching element 13 connects the working electrode 4 to a voltage supply unit 11 as desired. The voltage supply unit 11 is connected at the same time to a counterelectrode 8. The working electrodes 4 of the first and second liquid feed ducts 22 and 23 and the counterelectrode 7 can be connected by the switching element 12 to the voltage supply unit 10 as desired in this embodiment. By contrast, the working electrode 4 of the third liquid feed duct 24 and the counterelectrode 8 are supplied with electric voltage of the voltage supply unit 11 separately. A quantity of vapor to be generated can be increased or reduced as described with this arrangement, as a result of which a broad dynamic range of the liquid evaporator according to the present invention is attained.

The evaporating unit 16 is arranged downstream of the liquid feed ducts 22, 23 and 24 in the direction of flow of the liquid to be evaporated. The heating elements 17 are arranged at right angles to the liquid feed ducts 22, 23 and 24 within the evaporating unit 16. Individual evaporating channels 18 are provided within the evaporating unit 16 in the longitudinal direction of the liquid feed ducts 22, 23 and 24 in order to embody a large-area evaporating surface in an advantageous manner. Three to four evaporating channels 18 are preferably provided in individual units in the immediate vicinity of the outlet of the liquid feed ducts 22, 23 and 24, the heating elements 17 being arranged between the units of the evaporating channels 18. The liquid feed ducts 22, 23 and 24 are advantageously separated from the evaporating channels 18 by a metal mat 21. The liquid to be evaporated can thus spread out optimally from the liquid feed ducts 22, 23 and 24 onto the evaporating channels 18. A temperature sensor 19 is arranged in the immediate vicinity of the evaporating channels 18 in order to use a measured temperature to control the evaporating unit 16.

The schematic sectional view in FIG. 4 shows the liquid evaporator according to the present invention with three liquid feed ducts 22, 23 and 24, where porous sintered glass elements 15 are arranged between the first and second liquid feed ducts 22 and 23 and between the second and third liquid feed ducts 23 and 24. The porous sintered glass elements 15 are in contact with the liquid to be evaporated in the liquid reserve 1. The porous sintered glass elements 15 act in this arrangement as a wick, in which the liquid to be evaporated rises from the liquid reserve 1 because of the capillary effect. The working electrodes 4 are designed, in principle, according to the description of the design of the working electrode 4 in FIG. 2. In addition, the working electrodes 4 have a second hydrophobic layer 9 on the side facing away from the respective liquid feed duct 22, 23 and 24. The working electrode 4 of the liquid feed duct 22 is connected to both a switch 12 and a second working electrode 4 of a second liquid feed duct 23 adjoining the first liquid feed duct 22. The switching element 12 connects the two working electrodes 4 to the voltage supply unit 10 as desired. The voltage supply unit 10 is electrically connected at the same time to the counterelectrodes 7 and 8. The counterelectrodes 7 and 8 may advantageously also be designed as a common ring electrode, which surrounds all liquid feed ducts 22, 23 and 24. A third working electrode 4, which is connected to a switching element 13, is provided in a third liquid feed duct 24 adjoining the second liquid feed duct 23. Switching element 13 connects the working electrode 4 of the third liquid feed duct 24 to the voltage supply unit 10 as desired.

Both the working electrodes 4 of the first and second liquid feed ducts 22 and 23 and the working electrode 4 of the third liquid feed duct 24 may be supplied with electric voltage of the voltage supply unit 10 by the switching elements 12 and 13 as desired.

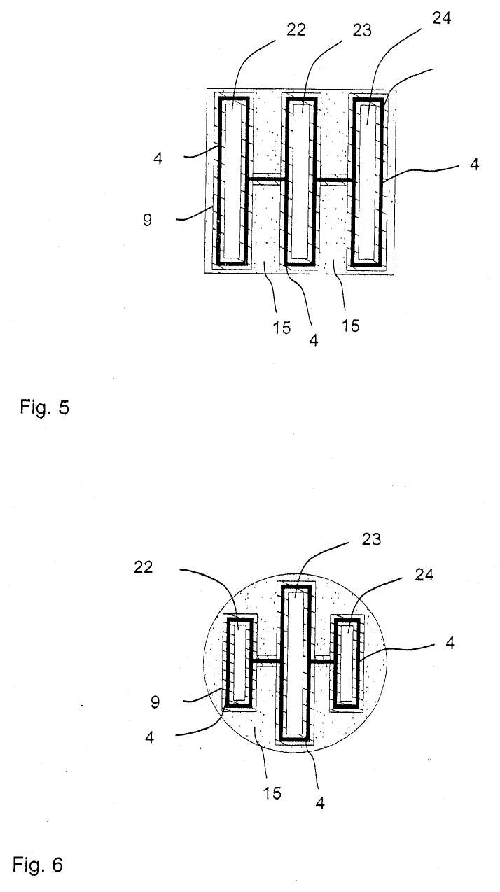

A basic quantity of liquid to be evaporated can be provided with this arrangement with the sintered glass elements 15. If needed, the quantity of liquid to be evaporated can be briefly increased by applying an electric voltage of the voltage supply unit 10 as desired by means of the switching element 12 to the working electrodes 4 of the first and second liquid feed ducts 22 and 23 as well as by means of the switching element 13 of the working electrode 4 of the third liquid feed duct 24. The quantity of vapor to be generated can thus be increased as desired beyond a basic quantity of vapor, whereby a broad dynamic range of the liquid evaporator according to the present invention beyond the basic quantity of vapor is obtained. A schematic sectional view of the liquid evaporator according to the present invention with three liquid feed ducts 22, 23 and 24, each with a rectangular cross section, is shown in FIG. 5. A working electrode 4 each, which is designed, in principle, according to the description of the design of the working electrode 4 in FIG. 2, is arranged in the individual liquid feed ducts 22, 23 and 24. Contrary to the embodiments according to FIGS. 3 and 4, the working electrodes 4 of the embodiment according to FIG. 5 are connected to one another. Porous glass elements 15 are arranged between the individual liquid feed ducts 22, 23 and 24. An electric voltage is applied between the working electrodes 4 and one or more counterelectrodes 7 and/or 8 (not shown).

FIG. 6 shows a schematic sectional view of the liquid evaporator according to the present invention with three liquid feed ducts 22, 23 and 24 of different cross-sectional areas. The respective outer liquid feed ducts 22 and 24 have a smaller cross-sectional area compared to the inner liquid feed duct 23. The individual liquid feed ducts 22, 23 and 24 have, as in the embodiment according to FIG. 5, a working electrode 4 each. The working electrodes 4 completely surround the respective liquid feed duct 22, 23 and 24. The liquid evaporator according to the present invention may have a round shape in this embodiment.

Vapor of a liquid to be evaporated can be generated rapidly with the liquid evaporator according to the present invention without the use of mechanical components subject to wear. The quantity of liquid to be evaporated can be actively controlled and modified by the design according to the present invention. In particular, it is possible with the liquid evaporator according to the present invention, in conjunction with a respirator or as a component of a respirator, to embody rapid vapor generation exclusively during the phase of inspiration.

While specific embodiments of the invention have been shown and described in detail to illustrate the application of the principles of the invention, it will be understood that the invention may be embodied otherwise without departing from such principles.

### LIST OF REFERENCE NUMBERS

1 Liquid reserve
2, 22, 23, 24 Liquid feed duct
3, 4 Working electrode
7, 8 Counterelectrode
9 Hydrophobic layer
10, 11 Voltage supply unit
12, 13 Switching element
14 Carrier unit
15 Porous sintered glass elements
16 Evaporating unit
17 Heating element
18 Evaporating channel
19 Temperature sensor
20 Liquid level in liquid feed duct
21 Metal mat

What is claimed is:

1. A liquid evaporator comprising:
a liquid reserve of a liquid to be evaporated;
a liquid feed duct;
an evaporating unit adjoining said liquid feed duct;
a working electrode forming at least one part of a wall of said liquid feed duct; and
a counterelectrode arranged at a spaced location from said working electrode, said working electrode and said counterelectrode cooperating to generate an electrical field by an electric voltage applied between said working electrode and said counterelectrode to bring about motion of said liquid to be evaporated through said liquid feed duct.

2. A liquid evaporator in accordance with claim 1, wherein said liquid feed duct has one of a rectangular and square cross section.

3. A liquid evaporator in accordance with claim 1, wherein said liquid feed duct has a round cross section.

4. A liquid evaporator in accordance with claim 1, wherein a diameter or a width of said liquid feed duct is selected as a function of a voltage to be applied to said working electrode and said counterelectrode.

5. A liquid evaporator in accordance with claim 1, wherein a diameter or a width of said liquid feed duct is selected as a function of the distance between said working electrode and said counterelectrode.

6. A liquid evaporator in accordance with claim 1, wherein said working electrode is held by a carrier unit, said carrier unit being composed of a material comprising silicon.

7. A liquid evaporator in accordance with claim 1, wherein said working electrode is provided with a hydrophobic layer, said hydrophobic layer comprising Polytetrafluoroethylene.

8. A liquid evaporator in accordance with claim 1, wherein said evaporating unit comprises a heating element arranged in a longitudinal direction of said liquid feed duct.

9. A liquid evaporator in accordance with claim 1, wherein said evaporating unit comprises a heating element arranged downstream of said liquid feed duct in a direction of flow of the liquid to be evaporated.

10. A liquid evaporator in accordance with claim 1, wherein said working electrode completely surrounds at least one portion of said liquid feed duct.

11. A liquid evaporator in accordance with claim 1, further comprising:
an additional liquid feed duct; and
at least one additional working electrode forming at least one part of a wall of said additional liquid feed duct, said working electrode being connected to said at least one additional working electrode.

12. A liquid evaporator in accordance with claim 11, further comprising:
an additional counterelectrode, said at least one additional working electrode cooperating with said additional counterelectrode.

13. A liquid evaporator in accordance with claim 12, further comprising:
a switching arrangement for separately supplying voltage to said working electrode and said counterelectrode and said at least one additional working electrode with said additional counterelectrode.

14. A liquid evaporator in accordance with claim 11, wherein a porous material is arranged between said liquid feed ducts.

15. A liquid evaporator in accordance with claim 1, wherein said counterelectrode is arranged outside of said liquid feed duct.

16. A liquid evaporator in accordance with claim 1, wherein a diameter or a width of said liquid feed duct has a value of less than 200 μm.

17. A liquid evaporator in accordance with claim 14, wherein said porous material is one of porous sintered glass and porous sintered ceramic elements.

18. A liquid evaporator comprising:
a liquid reservoir with a liquid reserve of a liquid to be evaporated;
a liquid feed duct extending into said liquid reserve in said liquid reservoir;
an evaporating unit adjoining said liquid feed duct for evaporating liquid;
a working electrode operatively connected to said liquid feed duct; and
a counterelectrode arranged at a spaced location from said working electrode, said working electrode and said counterelectrode cooperating to generate an electrical field by an electric voltage applied between said working electrode and said counterelectrode for moving said liquid to be evaporated through said liquid feed duct.

19. A liquid evaporator in accordance with claim 18, wherein said working electrode is provided with a hydrophobic layer.

20. A liquid evaporator in accordance with claim 18, further comprising:
an additional liquid feed duct;
at least one additional working electrode forming at least one part of a wall of said additional liquid feed duct, said working electrode being connected to said at least one additional working electrode; and
an additional counterelectrode, said at least one additional working electrode cooperating with said additional counterelectrode.
